(19) United States
(12) Patent Application Publication
(10) Pub. No.: US 2017/0117665 A1
(43) Pub. Date: Apr. 27, 2017

(54) LATCH MECHANISM AND SOCKET FOR ELECTRICAL COMPONENT

(71) Applicant: ENPLAS CORPORATION, Kawaguchi-shi, Saitama (JP)

(72) Inventor: Osamu HACHUDA, Kawaguchi (JP)

(73) Assignee: ENPLAS CORPORATION, Kawaguchi-shi, Saitama (JP)

(21) Appl. No.: 15/300,620

(22) PCT Filed: Mar. 27, 2015
(86) PCT No.: PCT/JP2015/059575

§ 371 Date: Sep. 29, 2016

(30) Foreign Application Priority Data
Mar. 31, 2014 (JP) 2014-071610

(51) Int. Cl. H01R 13/639; H01R 12/70

(52) U.S. Cl. CPC H01R 13/639; H01R 12/7011

(57) ABSTRACT

A latch mechanism for securely locking a latch and a socket for electrical component.

A cover member includes a cover body covering an upper side opening surface of a housing body, an elevating part supported by the cover body such that the elevating part can be moved up and down, and a pressing part supported by the cover body and moving down the elevating member. Top end portions of latch parts are rotatably supported on outside surfaces of the cover body. Bottom end portions of the latch parts are engaged with the housing body, so as to fix the cover body to the housing body. The elevating part is provided with latch locking parts that are engaged with the latch parts when moved down, so as to prevent the latch parts from rotating in a direction in which engagement between the latch parts and the housing body is released.

### TECHNICAL FIELD

The present invention relates to a latch mechanism capable of locking a latch and to a socket for electrical component housing an electrical component such as a semiconductor device (hereinafter referred to as an “IC package”).

### BACKGROUND ART

Conventionally, as a “socket for electrical component”, a socket is known that houses an electrical component such as a semiconductor device (hereinafter referred to as an “IC package”). As this type of socket for electrical component, there is an IC socket in which a socket body and a cover unit are completely separated, as described in, for example, Patent Literature 1.

In the IC socket of Patent Literature 1, as shown in FIG. 5 thereof, an IC package is housed in the socket body, and a push-fit cover unit is set to an upper surface thereof.

Further, a claw of a latch provided to this push-fit cover unit is engaged with a cover body part. On this occasion, this latch is biased in the closing direction by a coil spring, such that this push-fit cover unit is held by the socket body.

Then, a push-fit member provided to this push-fit cover unit is made to abut against the upper surface of the IC package, and an adjusting knob provided in a middle portion of this push-fit cover unit is rotated in a horizontal direction so as to press this push-fit member, thereby fixing this IC package.

In this manner, it is possible to fix this IC package with an appropriate pressing force.

### CITATION LIST

### Patent Literature

Patent Literature 1: Japanese Patent Laid-Open No. 2006-252946

### SUMMARY OF INVENTION

Technical Problem

However, in such a conventional socket, a latch was biased in the closing direction by a coil spring, such that this push-fit cover unit is held by the socket body. Accordingly, there was a possibility that the latch is unlocked due to the oscillation of the IC socket etc.

Accordingly, an object of the present invention is to provide a latch mechanism capable of securely locking a latch and a socket for electrical component using this latch mechanism.

### Solution to Problem

In order to achieve the object, the invention according to claim 1 provides a latch mechanism including: a cover member including a cover body covering an upper side opening surface of a housing body, an elevating member supported by the cover body such that the elevating part can be moved up and down, and a pressing part supported by the cover body and moving down the elevating member; a pair of latch parts whose top end portions are rotatably supported on outside surfaces of the cover body, and whose bottom end portions are engaged with the housing body, so as to fix the cover body to the housing body; and latch locking parts provided to the elevating part, and engaged with the latch parts when moved down, so as to prevent rotation of the latch parts in a direction in which engagement between the latch parts and the housing body is released.

In the invention according to claim 2, in addition to the configuration of claim 1, the top end portions of the latch parts are provided with shaft holes for inserting therein rotation shafts provided to the cover body, the bottom end portions of the latch parts are provided with locking claws to be locked to the housing body, the latch locking parts of the elevating part project in a horizontal direction, and locked portions, which are locked by the latch locking parts when the elevating part is moved down, are provided in the vicinity of the shaft holes of the latch parts.

The invention according to claim 3 provides a socket for electrical component, including: a socket body as the housing body in which an electrical component is housed in a housing portion provided in an upper surface side, and a contact pin to be electrically connected to the electrical component is provided; and the cover member removably provided to the socket body and covering the housing portion of the socket body, the socket for electrical component including: the latch mechanism according to claim 1 or 2.

### Advantageous Effects of Invention

According to the invention of claim 1, the latch locking parts are provided to the elevating part, and are engaged with the latch parts when the elevating part is moved down, so as to prevent the rotation of the latch parts. Thus, it is possible to securely lock the latch parts only with a simple operation.

According to the invention of claim 2, the latch locking parts of the elevating part project in a horizontal direction, and locked portions to be locked by the latch locking parts are provided in the vicinity of the shaft holes of the latch parts. Thus, it is possible to securely lock the latch parts with a simple operation.

According to the invention of claim 3, because the latch mechanism of the above-described claim 1 or 2 is used, it is possible to provide a socket for electrical component capable of securely locking the latches.

### BRIEF DESCRIPTION OF DRAWINGS

FIG. 1 is a perspective view showing the general configuration of a socket for electrical component in accordance with an embodiment 1 of the present invention.

FIG. 2 is an exploded perspective view showing the configuration of a socket body of the socket for electrical component in accordance with the embodiment 1.

FIG. 3 is a cross-sectional view showing the configuration of a contact module of the socket for electrical component in accordance with the embodiment 1.

FIG. 4 is an exploded perspective view showing the configuration of a cover member of the socket for electrical component in accordance with the embodiment 1.

FIG. 5 is a cross-sectional view showing the configuration of the cover member of the socket for electrical component in accordance with the embodiment 1.

FIG. 6A is a cross-sectional view showing the configurations of an elevating mechanism and a latch mechanism of the socket for electrical component in accordance with the embodiment 1.

FIG. 6B is a cross-sectional view showing the configurations of the elevating mechanism and the latch mechanism of the socket for electrical component in accordance with the embodiment 1.

FIG. 6C is a cross-sectional view showing the configurations of the elevating mechanism and the latch mechanism of the socket for electrical component in accordance with the embodiment 1.

FIG. 7A is a perspective view for explaining a usage method of the socket for electrical component in accordance with the embodiment 1.

FIG. 7B is a perspective view for explaining the usage method of the socket for electrical component in accordance with the embodiment 1.

FIG. 7C is a perspective view for explaining the usage method of the socket for electrical component in accordance with the embodiment 1.

### DESCRIPTION OF EMBODIMENTS

### Embodiment 1 of the Present Invention

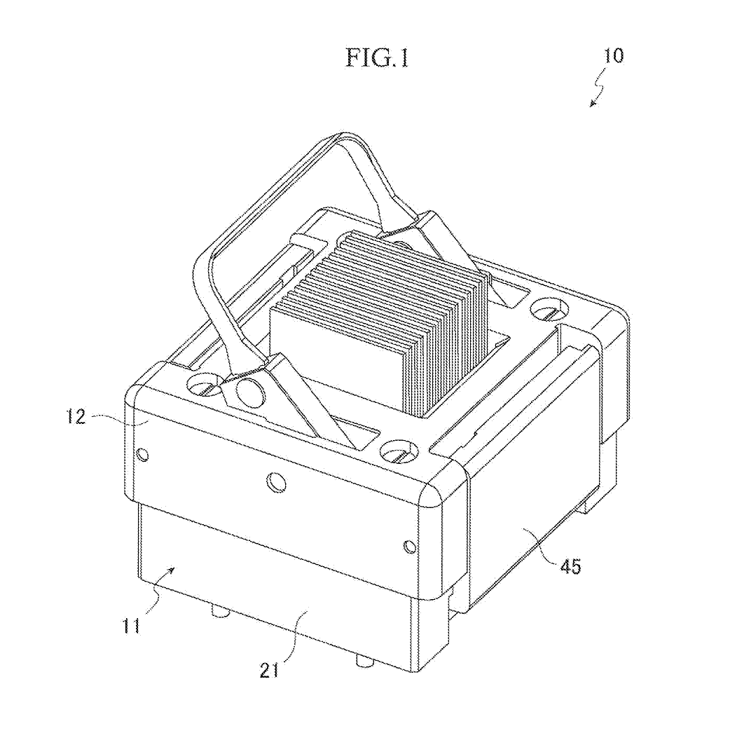

Hereinbelow, a description is given of an embodiment 1 of the present invention with reference to FIGS. 1 to 7.

As shown in FIG. 1 etc., an IC socket 10 as a “socket for electrical component” includes a socket body 11 as a “housing body” and a cover member 12.

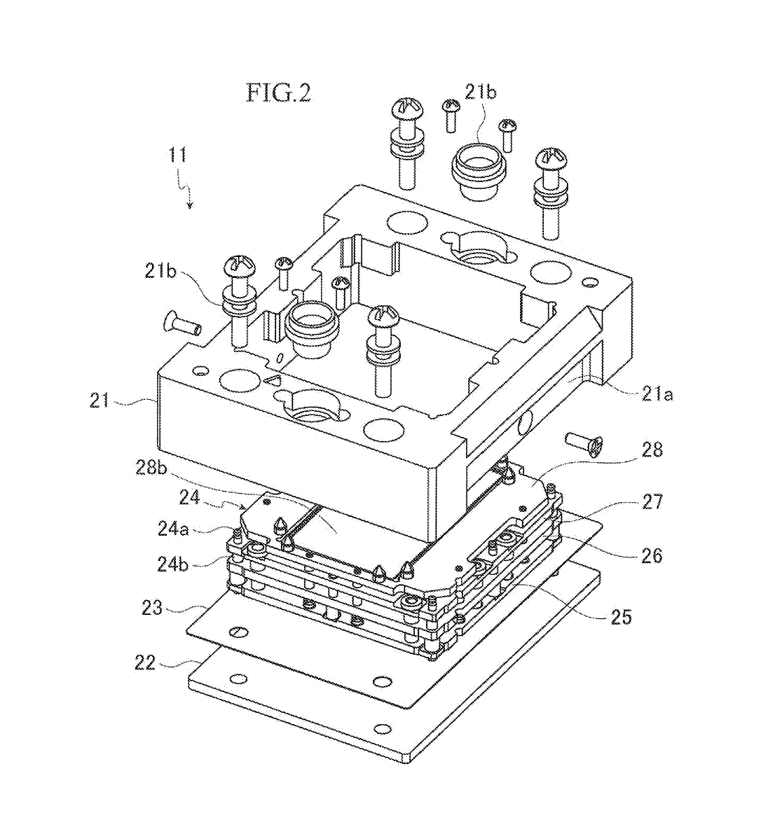

The socket body 11 includes, as shown in FIG. 2, a frame-shaped base part 21, a bottom plate 22 covering a bottom surface of this base part 21, an insulating plate 23 provided on an upper surface of this bottom plate 22, and a contact module 24 provided on this insulating plate 23 and housed in the base part 21.

On both left and right side surfaces of the base part 21, a pair of engaging concave portions 21a are formed to be engaged with engaging claws 45d, which are provided in bottom end portions of latches 45 described later, for fixing the socket body 11 and the cover member 12. In addition, in the vicinity of both front and back side surfaces of the base part 21, bushings 21b are provided for positioning the cover member 12 at the time of installation.

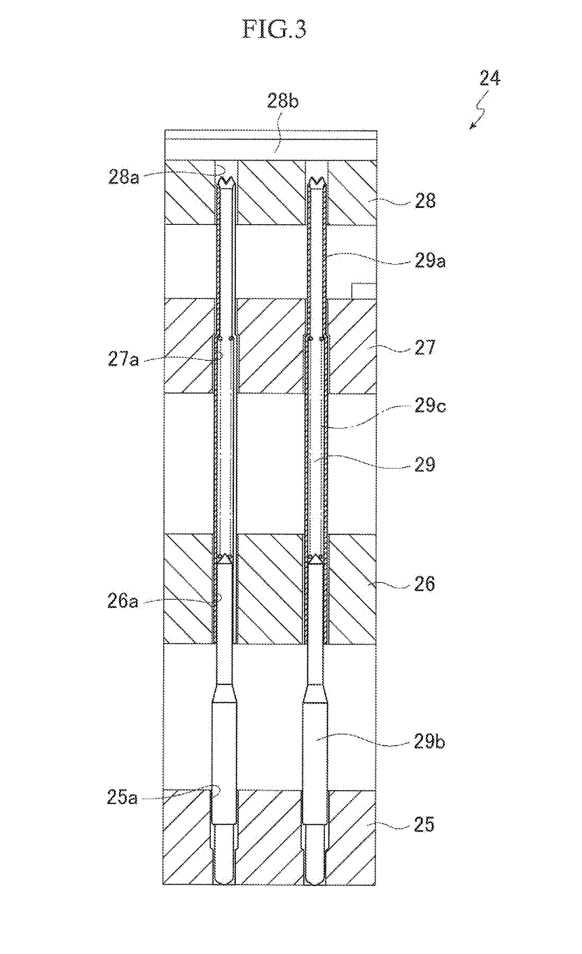

Additionally, in the contact module 24, as shown in FIGS. 2 and 3, a first plate 25, a second plate 26, a third plate 27 and a fourth plate (floating plate) 28 are arranged in this order from the bottom, and are fixed apart from each other by using screws 24a and spacers 24b.

Then, in each of these plates 25 to 28, respective through-holes 25a to 28a for housing contact pins 29 are formed.

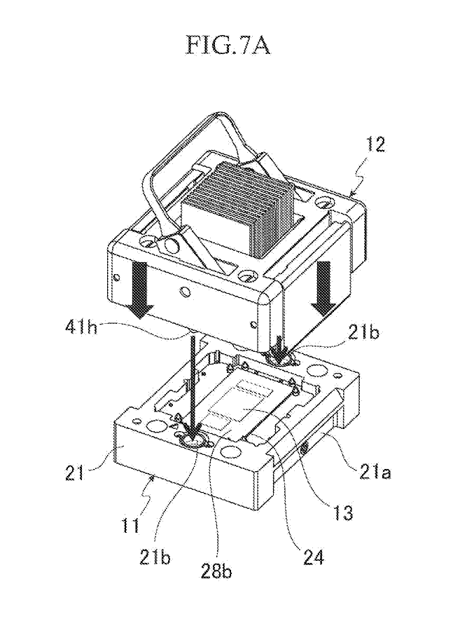

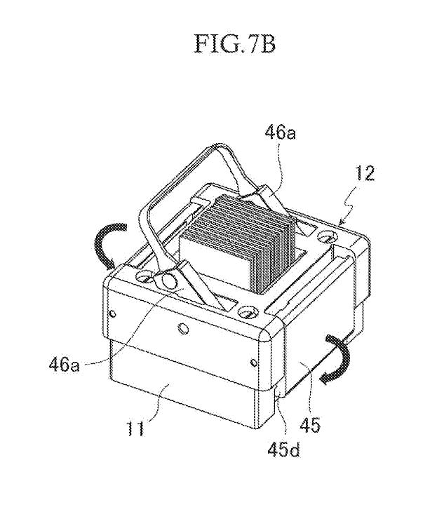

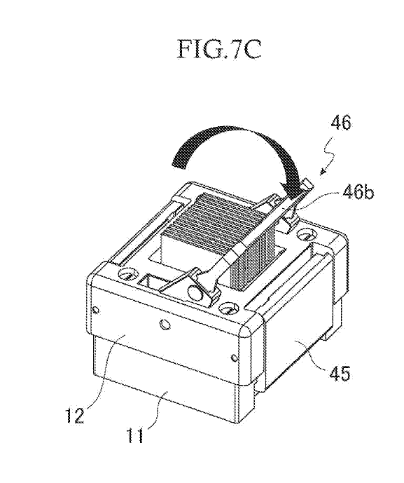

In addition, a housing portion 28b for housing an IC package 13 (see FIG. 7 described later) as an “electrical component” is provided in an upper surface of the topmost fourth plate 28. When the IC package 13 is housed in the housing portion 28b, each electrode terminal provided on a bottom surface of the IC package 13 is inserted into the through-hole 28a, and contacts the contact pin 29.

The contact pin 29 includes, as shown in FIG. 3, a conductive stepped cylindrical upper plunger 29a, a conductive stepped round bar-like lower plunger 29b, and a coil spring 29c. Then, the upper plunger 29a is made to contact with a spherical terminal (not shown) of the IC package 13, and the lower plunger 29b is made to contact with a wiring substrate (not shown), and further, these upper plunger 29a and lower plunger 29b are biased in mutually separating directions by the coil spring 29c, thereby electrically connecting the IC package 13 to the wiring substrate.

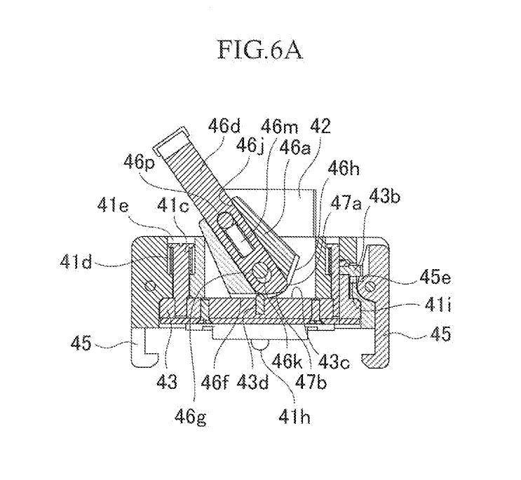

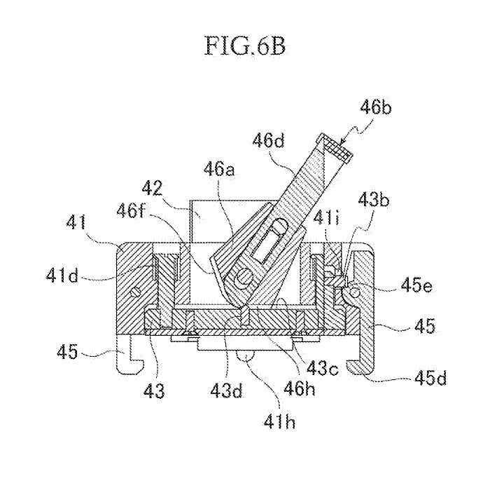

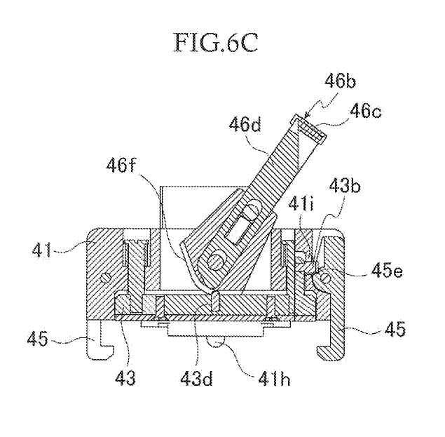

On the other hand, the cover member 12 includes, as shown in FIGS. 1, 4, 5 and 6A to 6C, a frame-like cover body 41 that is placed on the base part 21 of the socket body 11 and includes an opening in a middle portion in the up and down directions. On both left and ride side surfaces of the cover body 41, there are provided latch attaching dents 41a for fitting thereto top end portions 45a of the latches 45 (described later), and on both sides of the latch attaching dent 41a, there are provided shaft holes 41b for inserting therein a latch shaft 45b of the latch 45. Further, the cover body 41 is provided with screw holes 41e for inserting therein screws 41c for holding an elevating part 43 (described later) via springs 41d. Additionally, on end portions of these latch attaching dents 41a, there are provided vertically elongated holes 41i (see FIGS. 6A to 6C) for inserting therein latch locking parts 43b (described later). In addition, on an upper surface side in the vicinity of both front and back side surfaces of the cover body 41, there are provided pressing part insertion holes 41f for inserting therein a pressing part 46 (described later), and camshaft holes 41g for rotatably supporting this pressing part 46 with camshafts 46g. Then, on a lower surface side in the vicinity of both front and back side surfaces of the cover body 41, there are provided guide pins 41h for positioning for setting the cover member 12 to the socket body 11.

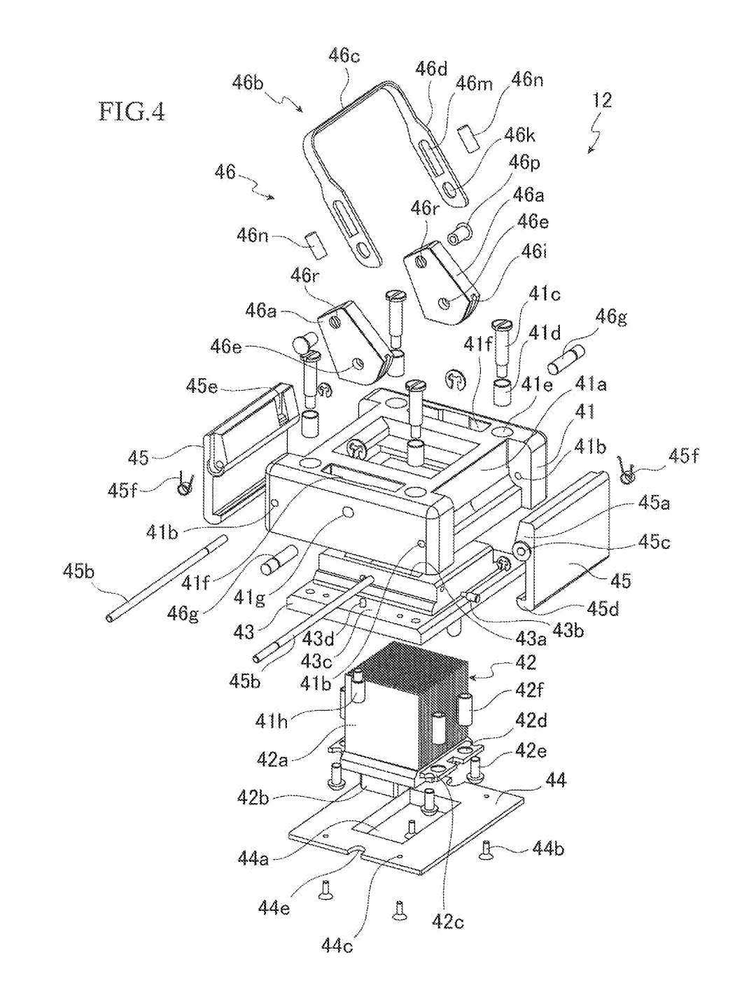

Additionally, the cover member 12 includes, as shown in FIG. 4, a heatsink 42 for fixing and performing heat dissipation for the IC package 13, the elevating part 43 for moving up and down the heatsink 42, and a back plate 44 for attaching the heatsink 42 to the elevating part 43.

On both left and right side surfaces of the heatsink 42, there are provided flange parts 42c extending toward an outer circumference direction, and each of the left and right flange parts 42c is provided with two recesses 42d. Springs 42f are fit into the recesses 42d. Additionally, screws 42e are screwed into screw holes (not shown) of the elevating part 43 via notches of the flange parts 42c, so as to fasten and fix the heatsink 42 to the elevating part 43.

The elevating part 43 is, as shown in FIG. 4, formed into a frame-like shape provided with an opening 43a in a middle portion in the up and down directions, and an upper portion 42a of the heatsink 42 is fit into this opening 43a. In addition, on both left and right side surfaces of the elevating part 43, there are provided the latch locking parts 43b (described later) by using, for example, a screw etc. Further, on a pressed surface 43c of the elevating part 43, there is provided cam locking parts 43d protruding therefrom for preventing the rotation of the pressing part 46 (described later) in the opposite direction.

Additionally, as shown in FIG. 4, the back plate 44 is also provided with an opening 44a in a middle portion in the up and down directions, and a lower portion 42b of the heatsink 42 is fit into this opening 44a. Further, the back plate 44 is provided with insertion holes 44c for inserting therein screws 44b, and notches 44e for positioning the back plate 44 by using the guide pins 41h.

Then, in a state where the lower portion 42b of the heatsink 42 is fit into the back plate 44, positioning is performed with the guide pins 41h, and fastening and fixing to a bottom surface of the elevating part 43 is performed by inserting the screws 44b into the insertion holes 44c from the down direction.

As shown in FIG. 4, the top end portions 45a of the latches 45 are fit into the latch attaching dents 41a of the cover body 41. A shaft hole 45c for inserting therein the latch shaft 45b is formed in the top end portion 45a of the latch 45, such that the shaft hole 45c penetrates therethrough in the front-back direction. Then, by inserting the latch shaft 45b into the shaft hole 45c of the latch 45 and shaft holes 41b of the cover body 41, the latch 45 is rotatably supported by the cover body 41. Additionally, a latch spring 45f for biasing the latch 45 in a closing direction is attached to each of the latch attaching dents 41a.

Here, when the latches 45 are rotated in the closing direction, it is possible to fix the cover member 12 to the socket body 11 by engaging the engaging claws 45d provided to the bottom end portions of the latches 45 with the engaging concave portions 21a (see FIG. 2) of the socket body 11. On the other hand, when the latches 45 are rotated in an opening direction, it is possible to remove the cover member 12 from the socket body 11 by releasing the engagement between the engaging claws 45d and the engaging concave portions 21a.

In addition, as shown in FIGS. 4 and 6A, the top end portions 45a of the latches 45 are provided with locking concave portions 45e as “locked portions” to be engaged with the latch locking parts 43b of the elevating part 43. As described later, when the elevating part 43 is moved down with the latches 45 closed, the latch locking parts 43b move down within the elongated holes 41i of the cover body 41 to be engaged with the locking concave portions 45e. Consequently, the rotation in the opening direction of the latches 45 is regulated, and locking is made in the closed state.

The above-described cover member 12, the pair of latches 45, the latch locking parts 43b and the locking concave portions 45e constitute a “latch mechanism” of the present invention.

Additionally, as shown in FIG. 4, the pressing part 46 is attached to the cover body 41. As described later, by rotating this pressing part 46, it is possible to press and move down the elevating part 43 to be pressed against an upper surface of the IC package 13.

The pressing part 46 includes a pair of first cams 46a and a bail 46b. The bail 46b includes a horizontal bar portion 46c, and a pair of second cams 46d that are bent at right angle and extend in a rotation radial direction from both ends of the horizontal bar portion 46c.

The first cams 46a are, as shown in FIG. 6A, provided with insertion slits 46j for inserting therein the bail 46b from the top end side. In addition, these first cams 46a are provided with shaft holes 46e and rivet holes 46r arranged along the rotation radial direction. Additionally, the bottom end portions of these first cams 46a are provided with, as shown in FIG. 6A, first cam surfaces 46f to be abut against the pressed surface 43c of the elevating part 43 in a state where the elevating part 43 is moved up, and second cam surfaces 46h to be abut against the elevating part 43 in a state where the elevating part 43 is moved down. Further, the first cam surfaces 46f and the second cam surfaces 46h of these first cams 46a are provided with, as shown in FIG. 4, grooves 46i along a rotation direction. When the first cams 46a are rotated, the cam locking parts 43d of the elevating part 43 pass through the inside of the grooves 46i.

The second cams 46d of the bail 46b include short elongated holes 46k and long elongated holes 46m arranged along the rotation radial direction. As shown in FIG. 6A, in the tips of the second cams 46d, lock portions 47a having a steep angle and gentle-angled portions 47b having a gentle angle are continuously formed via curved surfaces. In this manner, when the tips of the second cams 46d abut against the elevating part 43 to move down the elevating part 43, the tips of the second cams 46d are not locked by the cam locking parts 43d, and the gentle-angled portions 47b move on the pressed surface 43c. However, when an attempt is made to rotate the tips of the second cams 46d in the opposite direction, the lock portions 47a are locked by the cam locking parts 43d, and thus it is possible to prevent the rotation.

When assembling the pressing part 46, first, bail springs 46n are fit into the long elongated holes 46m. On this occasion, the bail springs 46n are fit so as to abut against tip-side end portions of the long elongated holes 46m. Then, after inserting the second cams 46d into the insertion slits 46j of the first cams 46a, rivets 46p are inserted into the rivet holes 46r of the first cams 46a and the long elongated holes 46m of the second cams 46d. In this manner, the first cams 46a are mounted to the bail 46b.

Next, the first cams 46a are inserted into the pressing part insertion holes 41f of the cover body 41, the camshafts 46g are put in from the camshaft holes 41g on both front and back side surfaces of this cover body 41 to be inserted into the shaft holes 46e of the first cams 46a and the short elongated holes 46k of the second cams 46d. In this manner, the first cams 46a and the second cams 46d are rotatably supported by the cover body 41, and it is possible to pull the second cams 46d in the rotation radial direction against the biasing force of the bail springs 46n.

Subsequently, a description is given of a usage method of the IC socket 10 in accordance with this embodiment 1.

First, as shown in FIG. 7A etc., the IC package 13 is housed in the housing portion 28b provided in the contact module 24 of the socket body 11.

Then, the cover member 12 is installed on this socket body 11. On this occasion, by inserting the guide pins 41h of the cover member into the bushings 21b of the base part 21, the socket body 11 is positioned with the cover member 12.

Further, as shown in FIG. 7B, the engaging claws 45d of the latches 45 provided to the cover member 12 are engaged with the engaging concave portions 21a (see FIG. 7A etc.) provided to the base part 21 of the socket body 11. On this occasion, the first cams 46a of the pressing part 46 abut against the pressed surface 43c of the elevating part 43 at the first cam surface 46f (see FIG. 6A). Additionally, on this occasion, as shown in FIG. 6A, the elevating part 43 is at the highest position due to the biasing force of the springs 41d. Thus, a bottom surface of the heatsink 42 is not pressed against the upper surface of the IC package 13.

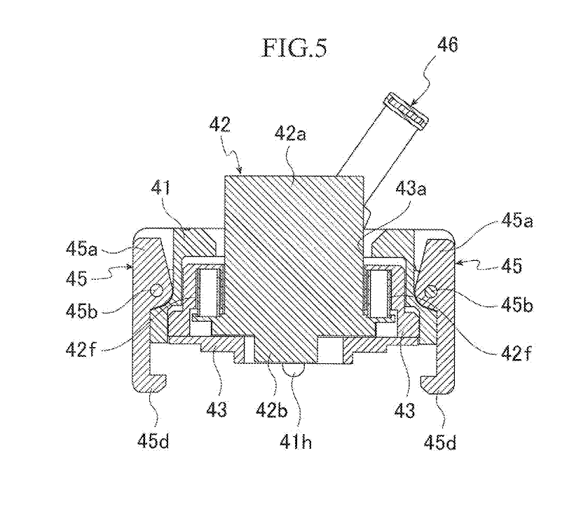

Thereafter, as shown in FIG. 7C, the bail 46b of the pressing part 46 is rotated from the left side to the right side in FIG. 7C. As described above, the shapes of the tips of the second cams 46d are formed such that the tips of the second cams 46d move on the pressed surface 43c without being locked by the cam locking parts 43d. Therefore, as shown in FIG. 6B, the second cams 46d can be rotated in accordance with the rotation of the bail 46b. In this manner, the first cams 46a are rotated in accordance with the rotation of the second cams 46d, and press the pressed surface 43c of the elevating part 43 in the down direction. Consequently, the elevating part 43 is moved down against the biasing force of the springs 41d, and the bottom surface of the heatsink 42 is pressed against the upper surface of the IC package 13. In this manner, the IC package 13 is fixed to the housing portion 28b. As described above, in this embodiment, the elevating part 43 is biased upwardly by the springs 41d provided in the cover body 41 (see FIG. 4, FIGS. 6A to 6C), and further, the heatsink 42 is biased downwardly by the springs 42f provided in the elevating part 43 (see FIG. 4, FIG. 5). Thus, it is possible to appropriately set the pressing force of the heatsink 42 with respect to the IC package 13.

Then, when the bail 46b is rotated to a predetermined position, the second cams 46d climb over the cam locking parts 43d, and the second cam surfaces 46h of the first cams 46a abut against the pressed surface 43c of the elevating part 43.

Additionally, on this occasion, since the elevating part 43 is moved down, the latch locking parts 43b descend within the elongated holes 41i of the cover body 41 to be engaged with the locking concave portions 45e of the latches 45. In this manner, the latches 45 are prevented from being rotated in the opening direction, and consequently, the cover member 12 cannot be removed from the socket body 11.

As described above, the shapes of the tips of the second cams 46d are formed such that the tips of the second cams 46d are engaged with the cam locking parts 43d, and the rotation in the opposite direction cannot be made. Thus, once the second cams 46d climb over the cam locking parts 43d, the first cams 46a also cannot be rotated in the opposite direction. Thus, IC socket 10 is locked in a state where the heatsink 42 is pressed against the IC package 13, and the engaging claws 45d of the latches 45 are engaged with the engaging concave portions 21a of the socket body 11.

On the other hand, when unlocking this lock, first, as shown in FIG. 6C, the horizontal bar portion 46c of the bail 46b is pulled up in a direction away from the elevating part 43. In this manner, because the tips of the second cams 46d are moved to be above the cam locking parts 43d, it is possible to rotate the second cams 46d in the opposite direction, that is, the left direction in FIG. 6C. Then, when the bail 46b is rotated in the opposite direction, and the tips of the second cams 46d climb over the cam locking parts 43d, the elevating part 43 is moved up to the highest position due to the biasing force of the springs 41d. In this manner, the heatsink 42 is moved up and separated from the IC package 13, and the engagement between the locking concave portions 45e of the latches 45 and the latch locking parts 43b of the elevating part 43 is released. Consequently, it is possible to remove the cover member 12 from the socket body 11 by releasing the engagement between the engaging claws 45d and the engaging concave portions 21a of the socket body 11.

As explained above, according to this embodiment 1, the latch locking parts 43b are provided to the elevating part 43, and are engaged with the latches 45 when the elevating part 43 is moved down, so as to prevent the rotation of the latches 45. Thus, it is possible to securely lock the latches 45 only with a simple operation.

Additionally, according to this embodiment 1, the latch locking parts 43b of the elevating part 43 project in the horizontal direction, and the locking concave portions 45e to be locked by the latch locking parts 43b are provided in the vicinity of the shaft holes 45c of the latches 45. Thus, it is possible to securely lock the latches 45 with a simple configuration.

### REFERENCE SIGNS LIST

10 IC socket

11 socket body

12 cover member

13 IC package

21 base part

21a engaging concave portion

22 bottom plate

23 insulating plate

24 contact module

41 cover body

42 heatsink

43 elevating part

43b latch locking part

43d cam locking part

44 back plate

45 latch

45e locking concave portion

46 pressing part

46a first cam

46b bail

46c horizontal bar portion

46d second cam

46k short elongated hole

46m long elongated hole

46n bail spring

1. A latch mechanism comprising:
a cover member including a cover body covering an upper side opening surface of a housing body, an elevating part supported by the cover body such that the elevating part can be moved up and down, and a pressing part supported by the cover body and moving down the elevating member;
a pair of latch parts whose top end portions are rotatably supported on outside surfaces of the cover body, and whose bottom end portions are engaged with the housing body, so as to fix the cover body to the housing body; and
latch locking parts provided to the elevating part, and engaged with the latch parts when moved down, so as to prevent rotation of the latch parts in a direction in which engagement between the latch parts and the housing body is released.

2. The latch mechanism according to claim 1,
wherein the top end portions of the latch parts are provided with shaft holes for inserting therein rotation shafts provided to the cover body,
the bottom end portions of the latch parts are provided with locking claws to be locked to the housing body,
the latch locking parts of the elevating part project in a horizontal direction, and
locked portions, which are locked by the latch locking parts when the elevating part is moved down, are provided in the vicinity of the shaft holes of the latch parts.

3. A socket for electrical component, including: a socket body as the housing body in which an electrical component is housed in a housing portion provided in an upper surface side, and a contact pin to be electrically connected to the electrical component is provided; and the cover member removably provided to the socket body and covering the housing portion of the socket body, the socket for electrical component comprising:
the latch mechanism according to claim 1.
